(19) United States
(12) Patent Application Publication
(10) Pub. No.: US 2006/0204024 A1
(43) Pub. Date: Sep. 14, 2006

(54) Remote control for a hearing aid

(75) Inventor: Pius A. Eicher, Opfikon (CH)

Correspondence Address: ROBERTS, MLOTKOWSKI & HOBBES, P. O. BOX 10064, MCLEAN, VA, 22102-8064, US

(73) Assignee: Phonak AG, Staefa (CH)

(21) Appl. No.: 11/370,165

(22) Filed: Mar. 8, 2006

(30) Foreign Application Priority Data
Mar. 8, 2005 (DE) 10 2005 010 625.0

(51) Int. Cl. H04R 25/00

(52) U.S. Cl. 381/315; 381/312

(57) ABSTRACT

A remote control for a hearing aid is described, comprising a transmitter unit (12, 24) for wireless transmission of control signals to the hearing aid, a control unit (14) which causes the transmitter unit to transmit the control signals, at least one manually operable control element (16, 18, 20, 30, 32, 34) acting on the control unit, and a storage (22) for electric energy. The transmitter unit (12, 24), the control unit (14), each control (16, 18, 20, 30, 32, 34) and the energy storage (22) are integrated into a writing device or into a housing having a shape of a writing device.

### BACKGROUND OF THE INVENTION

1. Field of the Invention

The present invention relates to a wireless remote control for a hearing aid.

2. Description of Related Art

A remote control for a hearing aid is known, for example, from U.S. Pat. No. 6,816,600 wherein the transmitter unit, the control unit, manual control elements and the energy storage are integrated into a wrist watch. Similar hearing aid remote controls are known, for example, also from U.S. Pat. No. 4,947,432, EP 1 355 512 A2, and U.S. Pat. No. 4,918,737.

In U.S. Pat. No. 5,081,441 a sound generator designed as a writing device is described, which is adapted for generating test sound signals for adjusting binaural hearing aids.

In U.S. Pat. No. 4,763,355 a writing device is described which is integrated into an arrangement for generating telephone tones.

In U.S. Pat. No. 5,289,544 a microphone designed as a writing device is described.

In DE 32 40 583 A1 a writing device comprising a miniaturized radio broadcast receiver unit is described.

It is an object of the invention to provide for a remote control for a hearing aid which is particularly unobtrusive and which can be manually controlled in a particularly simple manner.

### SUMMARY OF THE INVENTION

According to the invention this object is achieved by a remote control as defined in claims 1 and 18, respectively. These solutions are beneficial in that, since all essential components of the remote control, namely the transmitter unit, the control unit, each manual control element and the energy storage, are integrated within a handheld writing device or are arranged within a housing having the shape of a handheld writing device, on the one hand a particularly unobtrusive and anonymous manual control of the hearing aid is enabled and the other hand manual control of the remote control by using only one hand is enabled.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic view of a remote control for a hearing aid according to the invention, with the functional units located within the housing being shown schematically;

FIG. 2 is a side view of a first embodiment of a remote control according to the invention;

FIG. 3 is a view like FIG. 2, with a modified embodiment being shown; and

FIG. 4 is a schematic elevated view of the remote control of FIG. 3.

### DETAILED DESCRIPTION OF THE INVENTION

According to the invention a remote control for a hearing aid, with all essential components, is either integrated into a handheld writing device, i.e. a device for handwriting, which is actually working or the components are arranged within a housing having the shape of a handheld writing device, so that in both cases the remote control is not easily identified as a remote control by a neutral observer. Usually this is considered to be beneficial by the user of a hearing aid, since thereby it is not easy to recognize for other persons that a hearing aid is used or worn at all.

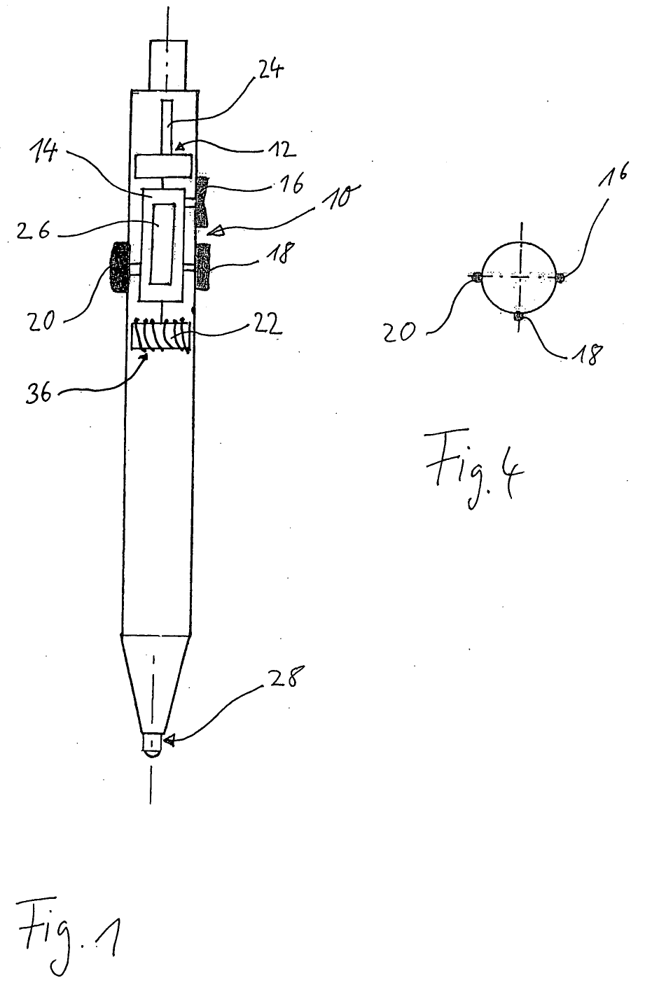

An example for the architecture of such a remote control 10 is schematically shown in FIG. 1. According to FIG. 1, the remote control 10 comprises a transmitter unit 12 for wirelessly transmitting control signals to the hearing aid, a control unit 14 causing the transmitter unit 12 to transmit the control signals, at least one manually operable control element 16, 18 and 20, respectively, acting on the control unit 14 and a storage 22 for electric energy serving as a power supply for the electrical components of the remote control 10. In the example of FIG. 1 the transmitter unit 12 is designed for transmitting radio frequency signals and therefore comprises an inductive transmitter antenna 24 which preferably is oriented to be aligned in the longitudinal direction of the writing device. The transmitter unit 12 preferably is designed for transmitting amplitude modulated or frequency modulated signals having a centre frequency of 10 kHz to 100 kHz.

The energy storage 22 preferably is rechargeable and to this end is either manually removable from the writing device or is provided with corresponding connections for a charging device (not shown). Alternatively, the energy stored may be inductively rechargeable. To this end, the energy storage 22 (which is typically an accumulator or a rechargeable battery) may be wound, as suggested, for example, in U.S. Pat. No. 6,498,155 B2, with an induction coil (receiver coil) 36 which serves for wireless (contact-less) transmission of energy from an external recharging coil (transmitter coil; not shown).

The remote control, for example, may be designed for controlling at least one of the following operational parameters of the hearing aid: type of the operating program, volume, directional characteristic, frequency characteristic (frequency filtering behaviour), etc. The remote control 10 may comprise an acoustic and/or optical display means 26 for displaying the charging level of the energy storage 22 and/or a feedback regarding manual operation of the control element 16, 18, 20. The writing device may be a pencil, a coloured pencil, a felt tip pen, a fountain pen or a ball-point pen. Furthermore, the writing device, for example, also could be a laser pointer having the shape of a writing device (in this case, the housing having the shape of a writing device in addition to the functional components of the remote control also would house a laser pointer).

Preferably, the essential elements of the remote control, i.e. the transmitter unit, the control unit 14, the manual control element 16, 18, 20 and the energy storage 22, are located in that portion of the writing device facing away from the tip 28 of the writing device. In this case the transmitter unit 12, the control unit 14 and the energy storage 22 preferably are arranged in the interior of the writing device so that they are not visible from outside.

Generally, the manual control elements acting on the control unit 14 may be rotary rings, sliders, push buttons and/or rotary buttons. If the control elements are rotary rings, these are preferably arranged concentrically with regard to the longitudinal axis of the writing device and are spaced apart from each other in the longitudinal direction of the writing device. If the control elements are sliders, these are preferably slideable along the longitudinal axis of the writing device. The sliders may be spaced apart from each other with regard to the peripheral direction of the writing device and/or the longitudinal direction of the writing device. In order to enable particularly easy and clear manual control of the remote control each manual control element may have a specific shape and/or marker, for example, a specific colour.

In FIG. 2 an embodiment is shown in which three rotary rings 30, 32, 34 are provided which are spaced apart from each other in the longitudinal direction of the writing device and which are arranged concentrically with regard to the longitudinal axis of the writing device.

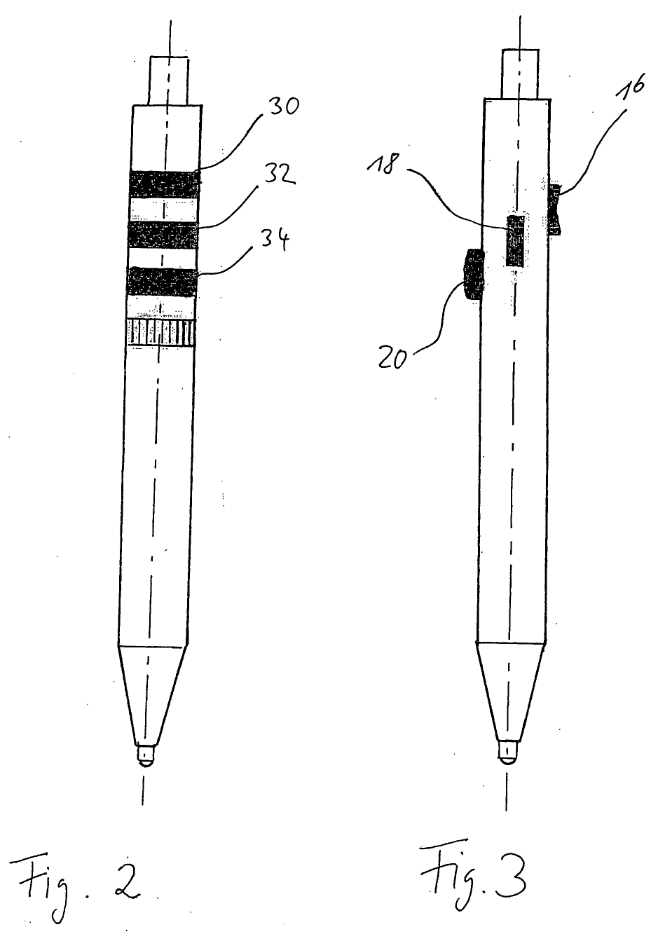

In FIGS. 3 and 4 a modified embodiment is shown in which three sliders 16, 18, 20 are provided which are slideable along the longitudinal direction of the writing device and which are spaced apart from each other in the peripheral direction of the writing device. Different positions of the sliders in the longitudinal direction of the writing device are dedicated to different functional positions.

The hearing aid (not shown) to be controlled is provided with a receiver unit which is adjusted to the transmitter unit 12 of the remote control 10.

In particular cases, even a bidirectional communication between the hearing aid and the remote control could be provided in order to display certain information regarding the operation condition of the hearing aid at the remote control acoustically and/or optically for the user of the hearing aid.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A remote control for a hearing aid, comprising a transmitter unit for wireless transmission of control signals to said hearing aid, a control unit which causes said transmitter unit to transmit said control signals, at least one manually operable control element acting on said control unit, and a storage for electric energy, wherein said transmitter unit, said control unit, each of said control elements and said energy storage are integrated into a writing device.

2. The remote control of claim 1, wherein said writing device is selected from the group consisting of a pencil, a coloured pencil, a felt tip pen, a fountain pen and a ball-point pen.

3. The remote control of claim 1, wherein said transmitter unit, said control unit, each of said control elements and said storage for electric energy are arranged in a portion of said writing device facing away from a tip of said writing device.

4. The remote control of claim 1, wherein said transmitter unit, said control unit and said storage for electric energy are arranged in an interior of said writing device.

5. The remote control of claim 1, wherein each of said control elements is selected from the group consisting of rotary rings, sliders, pushbuttons and rotary buttons.

6. The remote control of claim 5, wherein said rotary rings are arranged concentrically with regard to a longitudinal axis of said writing device and are spaced apart from each other in a longitudinal direction of said writing device.

7. The remote control of claim 5, wherein said sliders are slideable along a longitudinal axis of said writing device.

8. The remote control of claim 5, wherein said sliders are spaced apart from each other in at least one of a peripheral direction of said writing device and a longitudinal direction of said writing device.

9. The remote control of claim 1, wherein each of said control elements has at least one of a specific shape and a marker.

10. The remote control of claim 1, wherein said writing device comprises at least one of an acoustic display and an optical display for displaying at least one of a charge condition of said energy storage and feedback information regarding manual operation of one of said control elements.

11. The remote control of claim 1, wherein said transmitter unit is capable of transmitting radio frequency signals.

12. The remote control of claim 11, wherein said transmitter unit comprises an inductive transmission antenna.

13. The remote control of claim 12, wherein said transmission antenna is aligned in a longitudinal direction of said writing device.

14. The remote control claim 11, wherein said transmitter unit is capable of transmitting amplitude modulated or frequency modulated signals having a centre frequency of 10 kHz to 100 kHz.

15. The remote control of claim 1, wherein said energy storage is rechargeable.

16. The remote control of claim 15, wherein said energy storage is rechargeable in a contact-less manner via inductive energy transmission by means of an external transmitter coil and a receiver coil integrated within said writing device.

17. The remote control of claim 1, wherein said remote control is capable of controlling at least one of operational parameters of said hearing aid selected from the group consisting of operation program, volume, directional characteristic and frequency characteristic.

18. A remote control for a hearing aid, comprising a housing, a transmitter unit for wireless transmission of control signals to said hearing aid, a control unit which causes said transmitter unit to transmit said control signals, at least one manually operable control element acting on said control unit, and a storage for electric energy, wherein said transmitter unit, said control unit, each of said control elements and said energy storage are received within said housing, wherein said housing has a shape of a writing device.
